(19) United States
(12) Patent Application Publication
(10) Pub. No.: US 2006/0148283 A1
(43) Pub. Date: Jul. 6, 2006

(54) Surface-mount electrical connector with strain-relief features

(76) Inventors: Steven E. Minich, York, PA (US); Donald K. Harper JR., Camp Hill, PA (US)

Correspondence Address: WOODCOCK WASHBURN, LLP, ONE LIBERTY PLACE - 46TH FLOOR, PHILADELPHIA, PA, 19103, US

(21) Appl. No.: 11/027,727

(22) Filed: Dec. 30, 2004

(51) Int. Cl. H01R 12/00

(52) U.S. Cl. 439/70

(57) ABSTRACT

A preferred embodiment of an electrical connector includes a housing, and a surface mount conductor positioned on the housing. The surface mount conductor has a surface mount end. The electrical connector also includes a substrate penetrable electrical conductor positioned on the housing. The substrate penetrable electrical conductor provides strain relief for the surface mount conductor.

### FIELD OF THE INVENTION

The present invention relates to electrical connectors of the type that are mounted on a substrate using multiple solder connections.

### BACKGROUND OF THE INVENTION

Electrical connectors, such as ball-grid array (BGA) connectors, are commonly mounted on a substrate using multiple solder connections. The solder connections act as electrical and mechanical connections between the substrate and the connector.

The connector and the substrate typically operate at temperatures above ambient. Temperature changes can cause the connector and the substrate to deflect, i.e., to expand or contract. The amount of deflection of a component as a function of temperature change often is expressed as the coefficient of thermal expansion (CTE) for the component. The amount of deflection experienced by the connector and the substrate in response to a given temperature change usually differs. In other words, the CTEs of the connector and the substrate are usually different.

Differences between the amount of thermally-induced deflection of the connector and the substrate can induce stresses on the solder connections between the two components. These stresses, repeated over multiple heating and cooling cycles, referred to as “thermal cycling,” can weaken the solder connections. Weakening of a solder connection can affect the integrity of the signal transmission through the solder connection, and in extreme cases can result in separation of the solder connection from the connector or the substrate.

### SUMMARY OF THE INVENTION

The present invention seeks to add strain relief to a surface mountable connector by adding elongated contacts, such as ground or signal contacts, that extend into the substrate. This dual use of the contacts helps to eliminate the need for more traditional strain relief posts, which take up more real estate on the substrate. However, the use of traditional strain relief posts can still be used with the present invention.

A preferred embodiment of an electrical connector comprises a housing, and a surface mount conductor positioned on the housing. The surface mount conductor has a surface mount end. The electrical connector also comprises a substrate penetrable electrical conductor positioned on the housing. The substrate penetrable electrical conductor provides strain relief for the surface mount conductor.

Another preferred embodiment of an electrical connector comprises at least one of a housing and an insert molded leadframe assembly, and a surface mountable electrical conductor mounted on the at least one of a housing and an insert molded leadframe assembly. The electrical connector also comprises a fusible element coupled to the surface mountable electrical conductor for connecting the surface mountable electrical conductor to a surface of a substrate

The electrical connector further comprises at least one of a second electrical conductor mounted on the at least one of a housing and an insert molded leadframe assembly, the second electrical conductor having an elongated tail for engaging the substrate by way of a through hole formed in the substrate; and a post extending from the at least one of a housing and an insert molded leadframe assembly for engaging the substrate by way of another through hole formed in the substrate.

A preferred embodiment of a surface-mount electrical connector comprises at least one of a housing and an inset molded leadframe assembly, and a plurality of electrical conductors positioned on the at least one of a housing and an inset molded leadframe assembly. The surface-mount electrical connector also comprises a fusible element attached to a tail of a first of the electrical conductors for establishing an electrical connection between the first of the electrical conductors and a substrate by way of a contact pad located on a surface of the substrate.

The tail of the first of the electrical conductors has a first length and a tail of a second of the electrical conductors has a second length greater than the first length so that the tail of the second of the electrical conductors can establish electrical contact with the substrate by way of a plated through hole extending into a body of the substrate from the surface of the substrate.

### BRIEF DESCRIPTION OF THE DRAWINGS

The foregoing summary, as well as the following detailed description of a preferred embodiment, are better understood when read in conjunction with the appended diagrammatic drawings. For the purpose of illustrating the invention, the drawings show an embodiment that is presently preferred. The invention is not limited, however, to the specific instrumentalities disclosed in the drawings. In the drawings:

FIG. 1 is a top view of a preferred embodiment of an electrical connector having strain-relief features;

FIG. 2 is a top perspective view of the electrical connector shown in FIG. 1, taken through the line “A-A” of FIG. 1;

FIG. 3 is a bottom view of the electrical connector shown in FIGS. 1 and 2;

FIG. 4 is a magnified view of the area designated “B” in FIG. 2;

FIG. 5A is a magnified view of the area designated “C” in FIG. 4;

FIG. 5B is a view of the area “C” shown in FIG. 5A, from a perspective displaced ninety degrees from the perspective of FIG. 5A;

FIG. 6 is a magnified view of the area designated “D” in FIG. 4;

FIG. 7 is a magnified view of the area designated “E” in FIG. 4, and depicting the electrical connector mounted on a substrate;

FIG. 8 depicts an alternative embodiment of a contact of the electrical connector shown in FIGS. 1-7, taken from a perspective substantially identical to the perspective of FIG. 6;

FIG. 9 depicts the contact shown in FIG. 8, taken from a perspective substantially identical to the perspective of FIG. 7;

FIG. 10 is a perspective view of an alternative embodiment of the electrical connector shown in FIGS. 1-9; and

FIG. 11 is a perspective view of an insert molded leadframe assembly of the electrical connector shown in FIG. 10.

### DETAILED DESCRIPTION OF PREFERRED EMBODIMENTS

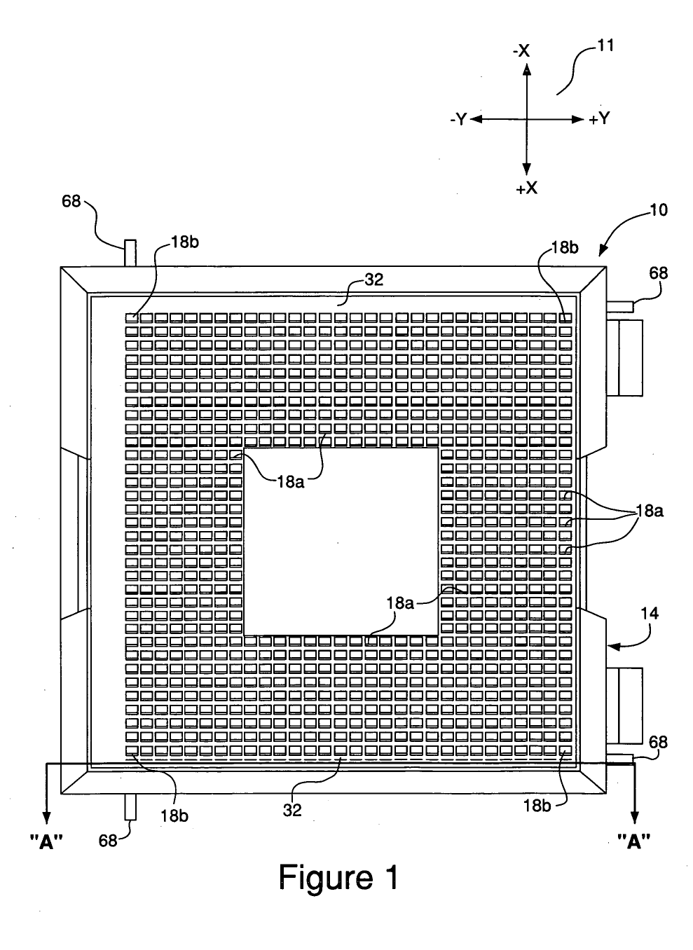

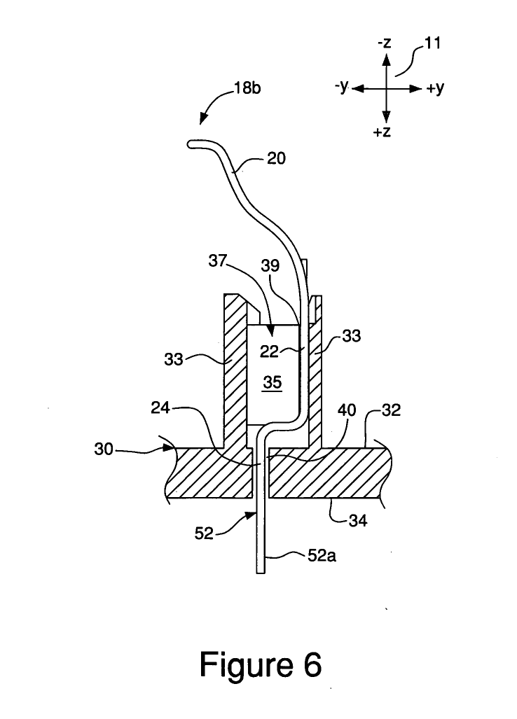

FIGS. 1-9 depict a preferred embodiment of an electrical connector 10. The figures are each referenced to a common coordinate system 11 depicted therein. The connector 10 is a socket for a BGA connector. This particular type of connector is disclosed for exemplary purposes only, as the principles of the present invention can be applied to other types of connectors.

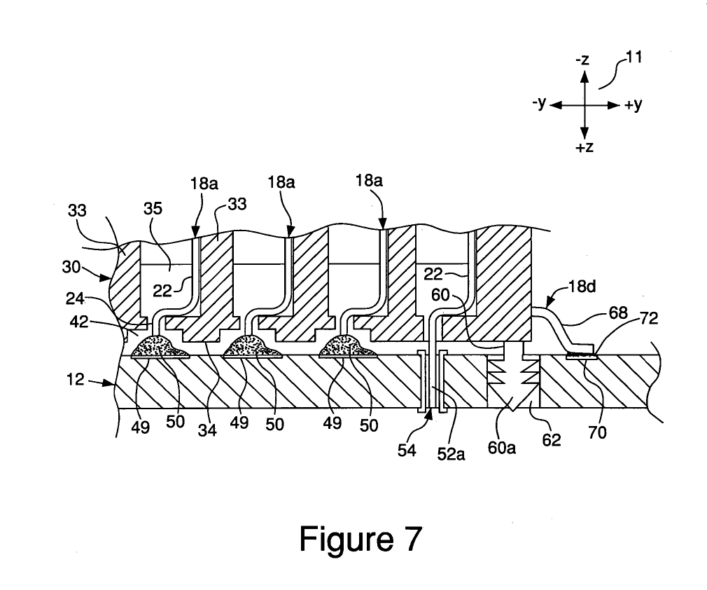

The connector 10 can be mounted on a substrate 12, as shown in FIG. 7). The substrate 12 can be, for example, a printed circuit board, a printed wire board, a backplane, etc.

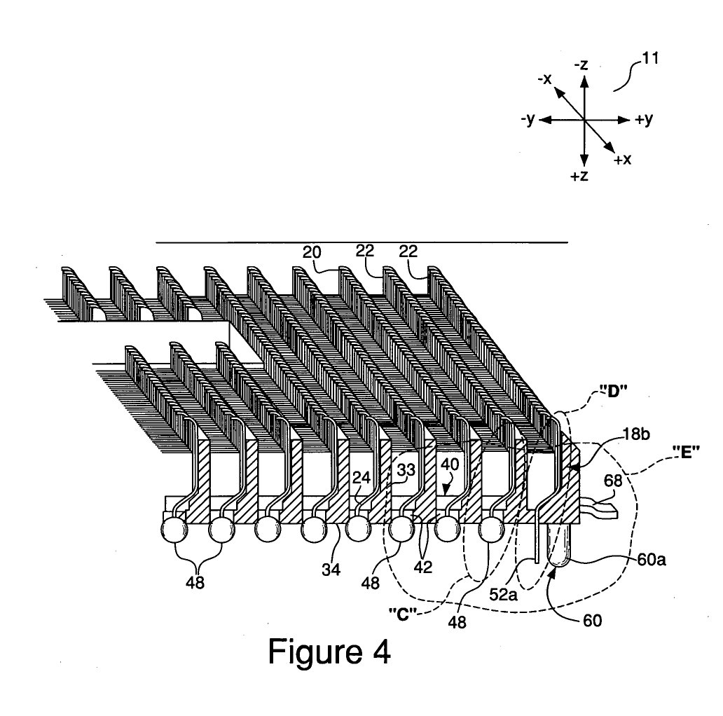

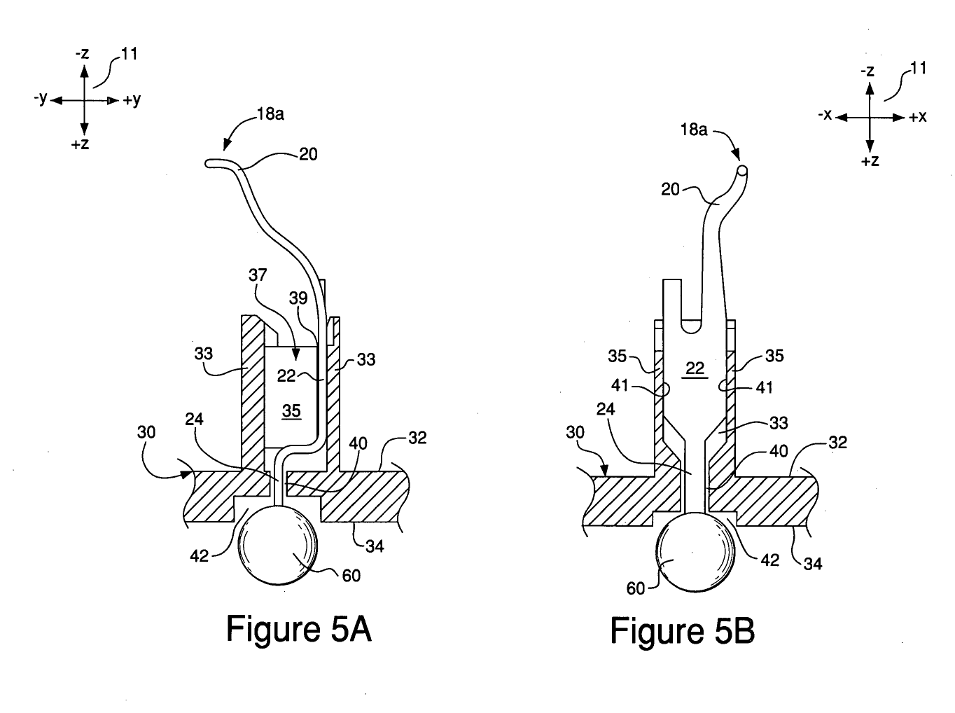

The connector 10 comprises a housing 14 formed from a suitable electrically-insulative material such as plastic. The connector 10 also comprises a plurality of electrical conductors in the form of contacts 18a mounted on the housing 14. The contacts 18a each include a contact portion 20, and an elongated body 22 that adjoins a first end of the contact portion 20. Each contact 18a also includes a substantially S-shaped tail 24 that adjoins a second end of the body 22 (see FIGS. 4-5B).

The housing 14 comprises a bottom portion 30 having an upper surface 32 and a lower surface 34. The housing 14 also includes a plurality of ribs 33 that project from the upper surface 32, and a plurality of partitions 35 positioned between adjacent ones of the ribs 33. For example, see FIGS. 4-5B. Opposing pairs of the ribs 33 and the associated partitions 35 define cavities 37 within the housing 14.

Directional terms such as top, bottom, upper, lower, etc., are used in reference to the component orientations depicted in FIGS. 1, 2, and 4-9; these terms are used for illustrative purposes only, and are not intended to limit the scope of the appended claims.

As shown in FIG. 5A, the partitions 35 have slots 39 formed therein. Each slot 39 extends substantially in the vertical (“z”) direction, and is defined by two beveled surfaces 41 of the partition 35. For example, see FIG. 5B. Each slot 39 receives an outer edge of the body 22 of an associated contact 18a.

As shown in FIGS. 4-6, the bottom portion 30 of the housing 14 has a plurality of penetrations 40 formed therein. Each penetration 40 receives a portion of a corresponding one of the tails 24. Each penetration 40 originates on the upper surface 32 of the bottom portion 30, and adjoins a corresponding one of the cavities 37.

The cavities 37 receive the contacts 18a. In particular, the body 22 of each contact 18a is positioned substantially within a corresponding one the cavities 37 so that the adjoining tail 24 extends through the associated penetration 40, and the contact portion 20 extends upward from the cavity 37 (see FIGS. 5A and 5B). The slots 39 associated with each cavity 37 receive opposing outer edges of the body 22. The beveled surfaces 41 that define each slot 39 contact an outer edge of the body 22, and help to restrain the associated contact 18a within the housing 14.

Referring to FIGS. 4-5B, a plurality of pockets 42 are formed in the bottom portion 30. Each pocket 42 extends inward from the lower surface 36 of the bottom portion 30, and adjoins a corresponding penetration 40. A portion of the tail 24 of each contact 18a extends from the corresponding penetration 40 and into a corresponding one of the pockets 42.

Alternative embodiments of the housing 14 can be formed without the pockets 42. Moreover, the contacts 18a can be formed as part of one or more insert-molded lead assemblies that, in turn, can be removably mounted on the housing 14 in alternative embodiments.

The connector 10 further comprises a plurality of fusible elements in the form of solder balls 48. Each solder ball 48 is associated with a corresponding one of the contacts 18a. As shown in FIGS. 4-5B, the solder balls 48 are positioned, in part, within a corresponding one of the pockets 42 of the housing 14. Each solder ball 48 is mounted on the tail 24 of the corresponding contact 18a.

The solder balls 48 are used to electrically and mechanically connect the connector 10 to the substrate 12. In particular, as shown in FIG. 7, each solder ball 48 aligns with a corresponding contact pad 49 on the substrate 12 when the connector 10 is placed thereon. The solder balls 48 are subjected to a reflow process that melts the solder balls 48. The melting and subsequent re-hardening of the solder forms solder connections 50 between the tails 24 of the contacts 18a and the corresponding contact pads 49.

The solder connections 50 form a mechanical connection between the tails 24 of the contacts 18a, the housing 14, and the corresponding contact pads 49. Hence, the solder connections 50 can be subject to stresses induced by differences between the thermal expansion of the substrate 12 and the housing 14.

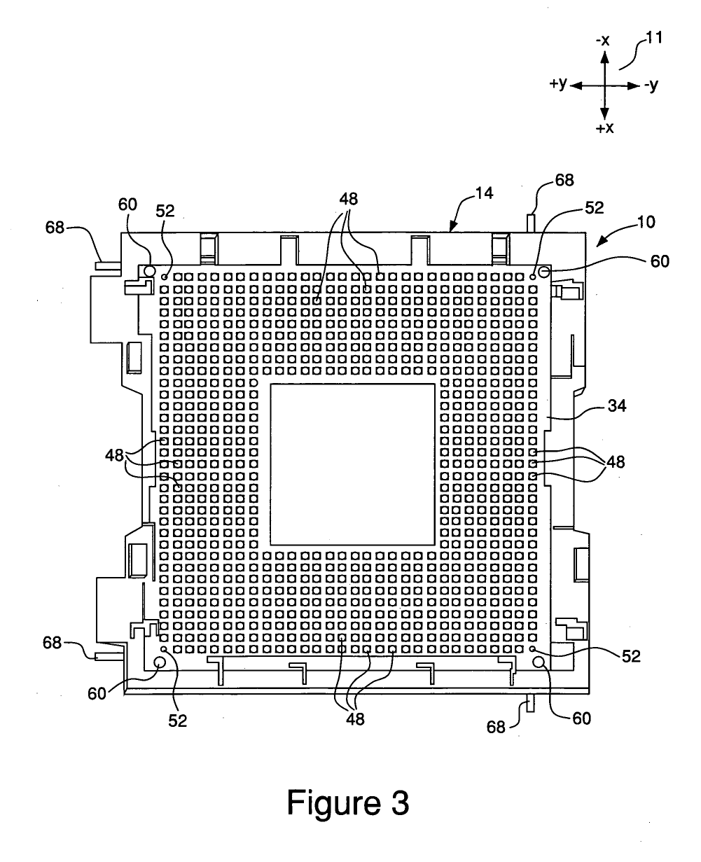

The connector 10 can be provided with one or more additional features to relieve the stresses, and the accompanying strain, that can occur in the solder connections 50 due to the differing thermal expansion of the substrate 12 and the housing 14. As shown in FIGS. 3, 4, 6, and 7, for example, the connector 10 can include one or more electrical conductors in the form of contacts 18b. The contacts 18b are substantially similar to the contacts 18a, with the following exception. The contacts 18b are each equipped with a tail 52 in lieu of the tail 24.

The tail 52 of each contact 18b adjoins the body 22 thereof. Components of the contacts 18a, 18b that are substantially identical are referred to using identical reference numerals. The body 22 of each contact 18b is positioned within the cavity 37 of the housing 14 in the manner described above in relation to the contacts 18a.

As illustrated in FIG. 7, the tail 52 of each contact 18b is elongated, so that a lower portion 52a of the tail 52 is received by a plated through hole 54 formed in the substrate 12. The tail 52 thus acts as a through pin. The tail 52 preferably has a substantially circular cross section, although other types of cross-sections, e.g., rectangular, can be used in the alternative. The tails 52 can be electrically and mechanically connected to the plating that lines the through hole 54 or via a suitable process such as soldering.

The contacts 18b can reduce the stresses within the solder connectors 50 resulting from differential thermal expansion between the housing 14 and the substrate 12. In particular, the body 22 of each contact 18b is restrained by the housing 14, and the tail 52 is restrained by the substrate 14. This arrangement causes the contact 18b to react the lateral “x” and “y” direction forces imposed thereon as the surrounding portion of the housing 14 attempts to move in relation to the substrate 12. The contacts 18b can thereby resist lateral movement of the housing 14 in relation to the substrate 12. The contacts 18b, by restraining the housing 14 in relation to the substrate 12, can reduce or substantially eliminate the strain on the solder connections 50 that otherwise would be caused by caused by differential thermal expansion between the housing 14 and the substrate 12.

The contacts 18b can be used as part of a signal or a ground path, like the contacts 18a. In other words, the contacts 18b can be used in place of one of the contacts 18a. The contacts 18b therefore can provide the above-noted strain-relief function without consuming additional space on the connector 10 or the substrate 12.

The connector 10 is depicted with one of the contacts 18b located proximate each corner of the housing 14 for illustrative purposes only. The optimal number of the contacts 18b in a particular connector is application dependent. For example, the optimal number of the contacts 18b can vary with factors such as the size of the connector, and the maximum anticipated difference between the thermal expansion of the connector housing and the associated substrate. The optimal locations for the contacts 18b likewise are application dependent. For example, for a substantially square connector such as the connector 10, the contacts 18b preferably are located proximate the outer corners thereof. These locations are considered optimal because the maximum differential thermal expansion between a substantially square connector, such as the connector 10, and the substrate 12 is believed to occur at or proximate the outer corners of the housing.

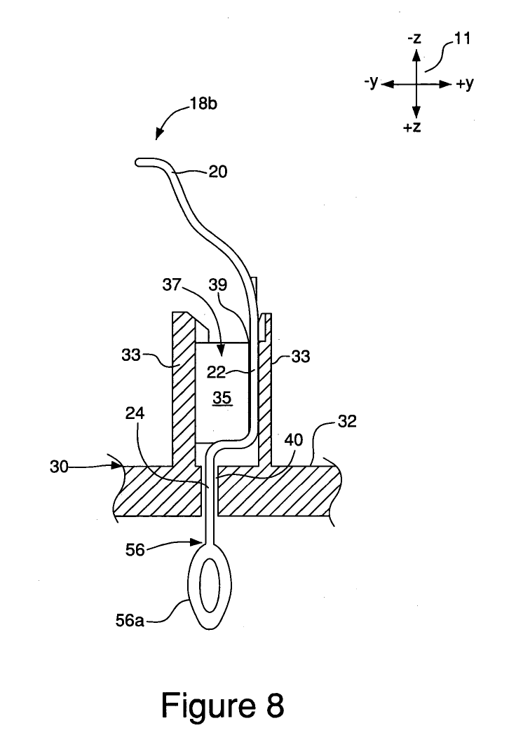

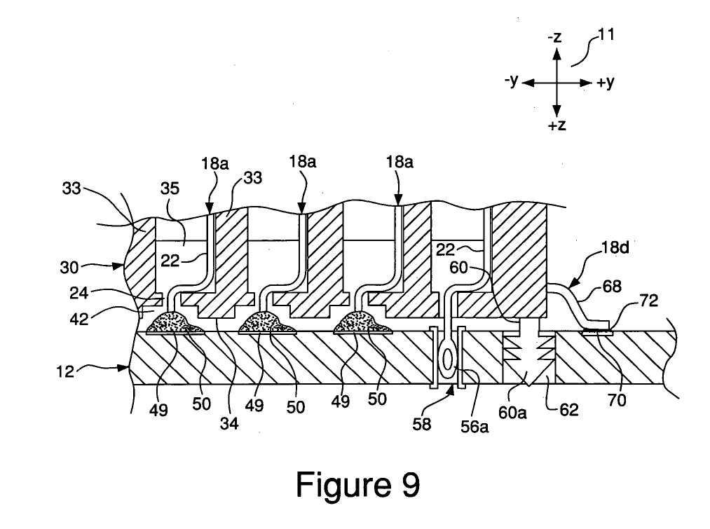

Referring to FIGS. 8 and 9, the connector 10 can be equipped with one or more electrical conductors in the form of contacts 18c in lieu of, or in addition to the contacts 18b. The contacts 18c are substantially similar to the contacts 18a and the contacts 18b, with the following exception. The contacts 18c are each equipped with a tail 56 in lieu of the tail 24 or the tail 52.

The tail 56 of the contact 18c adjoins the body 22 thereof. Components of the contacts 18a, 18c that are substantially identical are referred to using identical reference numerals. The body 22 of each contact 18c is positioned within the cavity 37 of the housing 14 in the manner described above in relation to the contacts 18a.

The tail 56 is configured as a press fit contact, also commonly referred to as an “eye of the needle” contact. A lower portion 56a of the tail 56 is received by a plated through hole 58 formed in the substrate 12. The through hole 58 and the lower portion 56a preferably are sized to so that the lower portion 56a fits snugly within the through hole 58.

The tail 56 establishes electrical and mechanical contact between the connector 10 and the substrate 12, like the tails 52 of the contacts 18b. The tail 56, however, does not require soldering or other additional processes to establish electrical and mechanical contact with the substrate 12.

The tails 56 can react lateral forces exerted thereon, and can restrain the housing 14 in relation to the substrate 12 in a manner similar to the tails 52 of the contacts 18b. The contacts 18c thereby can substantially reduce or eliminate stresses on the solder connections 50 that otherwise would result from differential thermal expansion between the housing 14 and the substrate 12. Moreover, the contacts 18b can perform this function without requiring additional space on the connector 10 or the substrate 12.

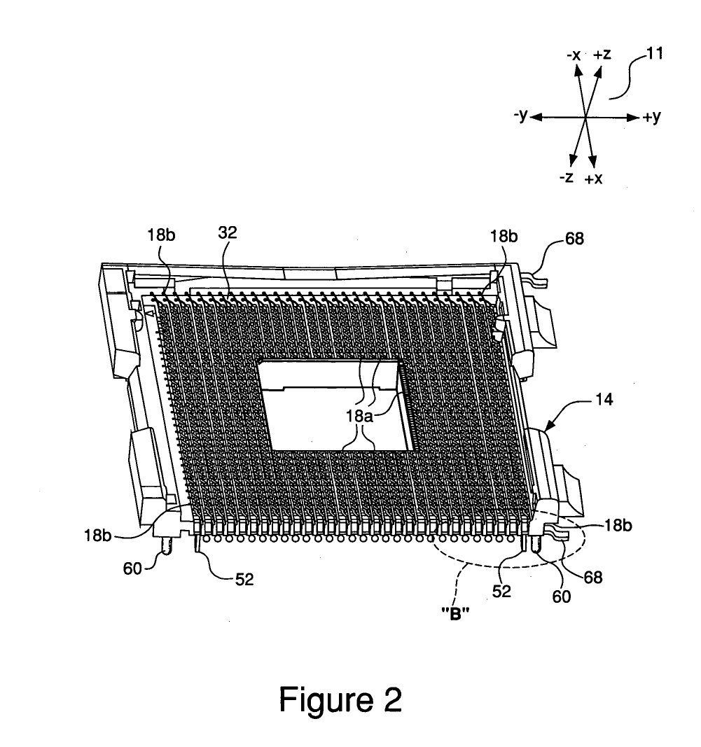

The housing 14 can include another type of strain-relief feature in the form of one or more posts 60, as shown in FIGS. 2-4, 7, and 9. The posts 60 can be used to further relieve stresses on the solder connections 50 caused by differential thermal expansion between the housing 14 and the substrate 12.

Referring to FIGS. 7 and 9A, a lower portion 60a of each post 60 is received in a through hole 62 formed in the substrate 12. The respective diameters of the through hole 62 and the post 60 preferably are sized so that the lower portion 60a fits snugly within the through hole 62. It should be noted that the optimal diameter of the through hole 62 is application dependent, and can vary with factors such as maximum lateral force that the associated post 60 will be subjected to; a particular value is specified for exemplary purposes only. For example, it is also possible to solder the post 60 in the through hole 62. In this case, the outer diameter of the post 60 can be even smaller than the interior diameter of the through hole 62.

In a press-fit type of arrangement, the lower portion 60a of the post 60 may have a “fir tree” configuration as depicted in the figures, to help minimize the potential for the post 60 to back out of the through hole 62. The lower portion 60a also can be configured differently in alternative embodiments. For example, the lower portion 60a can be formed with a relatively constant outer diameter in the alternative.

The posts 60 can be integrally formed with the housing 14 be a suitable process such as injection molding. Alternatively, the posts can be separately formed from a suitable material such as plastic or metal, and the housing 14 can be molded over the upper portion of each post 60.

The posts 60 can react lateral forces exerted thereon, and can restrain the housing 14 in relation to the substrate 12 in a manner similar to the tails 52, 56 of the contacts 18b, 18c. The posts 60 thereby can substantially reduce or eliminate stresses on the solder connections 50 that otherwise would result from differential thermal expansion between the housing 14 and the substrate 12.

The connector 10 is depicted with one of the posts 60 located proximate each corner of the housing 14 for exemplary purposes only. Alternative embodiments can include more or less than four of the posts 60, at locations other than those depicted in the figures.

As shown in FIGS. 1-4, 7, and 9, the connector 10 can include another type of strain-relief feature in the form of one or more electrical conductors configured as contacts 18d. The contact 18d each comprise a gull wing surface mount lead 68. The contacts 18d can be used to further relieve stresses on the solder connections 50 caused by differential thermal expansion between the housing 14 and the substrate 12.

Each contact 18d can further include a body 22 (not shown) that adjoins the lead 68, and a contact portion 20 (also not shown) that adjoins the body 22, as described above in relation to the contacts 18a. The contacts 18d can be used as part of a signal or ground path.

As shown in FIGS. 7 and 9, each lead 68 can be mechanically and electrically connected to a corresponding contact pad 70 on the substrate 12, by a suitable means such as soldering. The resulting solder connections 72, or other means of connection, are relatively large due to the relatively large size of the footprint of the lead 68 on the associated contact pad 70. The relatively large solder connections 72 can react lateral forces exerted thereon, and can restrain the housing 14 in relation to the substrate 12. The use of the lead 68 thereby can substantially reduce or eliminate stresses on the solder connections 50 that otherwise would result from differential thermal expansion between the housing 14 and the substrate 12.

As the leads 68 are surface-mounted, the contacts 18d can provide the noted strain relief without the need to place through holes in the substrate 12. Moreover, different ones of the leads 68 can be oriented in differently on the connector 10, to help maximize the strain relief provided by the leads 68 in both the “x” and “y” directions.

The connector 10 is depicted with one of the contacts 18d located proximate each corner of the housing 14 for exemplary purposes only. Alternative embodiments can include more or less than four of the contacts 18d, at locations other than those depicted in the figures.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may effect numerous modifications to the invention as described herein, and changes may be made without departing from the scope and spirit of the invention as defined by the appended claims.

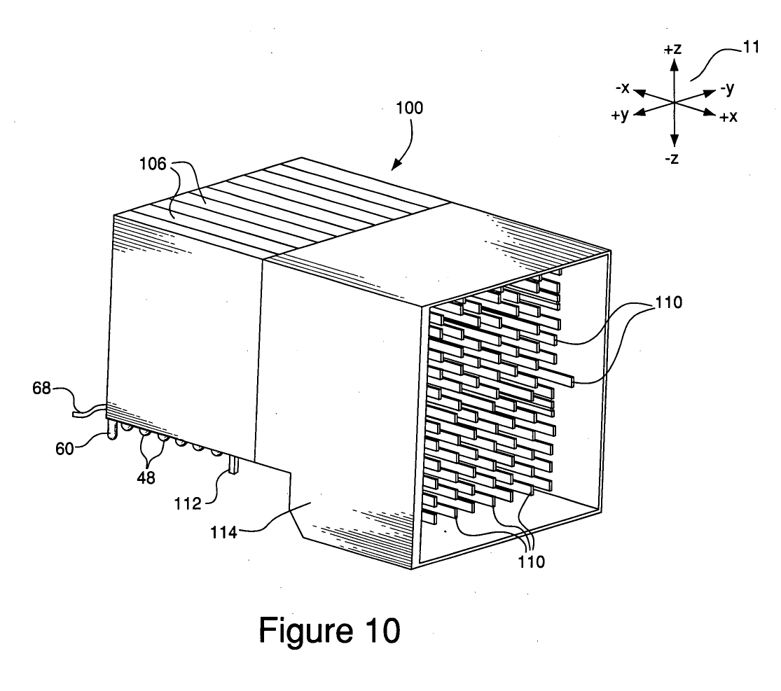

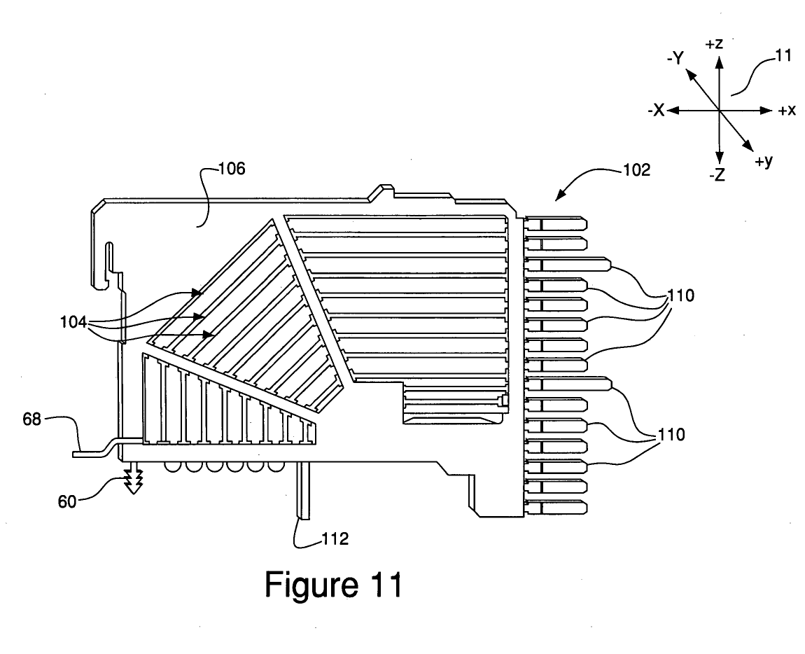

For example, the above-described strain-relief features can be applied to a header connector 100 as depicted in FIGS. 10 and 11. The header connector 100 comprises a plurality of insert molded leadframe assemblies (IMLAs) 102. Each IMLA 102 includes a plurality of electrical conductors 104 that extend through an overmolded frame 106.

Each electrical conductor 104 can include a lead portion 108, a blade contact 110 adjoining a first end of the lead portion 108, and a tail adjoining a second end of the lead portion 108. One or more of the tails can be configured in a manner substantially identical to the tails 52 of the contacts 18b, or the tail 56 of the contacts 18c. For example, one of the electrical conductors 104 of each IMLA 102 includes a tail 112 that is substantially identical to the tail 52. The tail 112 can perform the strain-relief functions described above in relation to the contacts 18b, 18c, when the header connector 100 is mounted on a substrate such as the substrate 12.

The header connector 100 also comprises an electrically-insulative housing 114. Ten of the IMLAs 102 are positioned within the housing 114 in a side by side arrangement. Alternative embodiments can include more or less than ten of the IMLAs 102. The tails extend downward from the housing 114. The blade contacts 110 are positioned within a forward portion of the housing 114.

The tails of some or all of remaining electrical conductors 104 can be configured in a manner substantially similar to the tails 24 of the contacts 18a. Fusible elements, such as the solder balls 48 of the connector 10, can be attached to these tails to form a ball grid array for mounting the header connector 100 on a substrate such as the substrate 12.

One or more of the IMLAs 102 can include one or more of the posts 60 described above in relation to the connector 10. Moreover, one or more of the electrical conductors 104 can be configured to include the gull wing surface mount leads 68 described above in relation to the connector 10. The header connector 100 can include these features in addition to, or in lieu of the tails 112.

1. An electrical connector comprising:
a housing;
a surface mount conductor positioned on the housing, the surface mount conductor having a surface mount end;
a solder ball positioned on the surface mount end of the surface mount conductor; and
a substrate penetrable electrical conductor positioned on the housing;
wherein the substrate penetrable electrical conductor provides strain relief for the surface mount conductor.

2. The electrical connector of claim 1, wherein the substrate penetrable electrical conductor defines an elongated end selected from the group comprising a press-fit end and a straight end.

3. (canceled)

4. The electrical connector of claim 1, further comprising a leadframe assembly, wherein the surface mount conductor is attached to the leadframe assembly and the leadframe assembly is attached to the housing.

5. The electrical connector of claim 1, further comprising a leadframe assembly, wherein the substrate penetrable conductor is attached to the leadframe assembly and the leadframe assembly is attached to the housing.

6. The electrical connector of claim 1, wherein the housing further comprises a strain relief post for engaging a substrate by way of a through hole defined by the substrate.

7. The electrical connector of claim 1, wherein the surface mount conductor defines a gull wing shaped surface mount end.

8. The electrical connector of claim 1, wherein the tail of the substrate penetrable conductor restrains the housing in relation to a substrate.

9. A leadframe comprising:
a surface mountable electrical conductor and
an elongated press-fit tail adapted to compress the surface mount electrical conductor against a substrate and provide strain relief for the surface mount electrical conductor.

10. (canceled)

11. The electrical connector of claim 15, wherein the post has a fir-tree cross-sectional configuration.

12. The electrical connector of claim 15, wherein the post is integrally formed with a remainder of the at least one of a housing and an insert molded leadframe assembly.

13. A surface-mount electrical connector, comprising:
at least one of a housing and an inset molded leadframe assembly;
a plurality of electrical conductors positioned on the at least one of a housing and an inset molded leadframe assembly; and
a fusible element attached to a tail of a first of the electrical conductors for establishing an electrical connection between the first of the electrical conductors and a substrate by way of a contact pad located on a surface of the substrate;
wherein the tail of the first of the electrical conductors has a first length and a tail of a second of the electrical conductors has a second length greater than the first length so that the tail of the second of the electrical conductors can establish electrical contact with the substrate by way of a plated through hole extending into a body of the substrate from the surface of the substrate.

14. The electrical connector of claim 13, wherein the tail of the second of the electrical conductors is selected from the group comprising a press-fit end and a straight end.

15. The electrical connector of claim 9, further comprising a post extending from the leadframe for engaging the substrate by way of a through hole formed in the substrate.

16. An electrical connector comprising:
a housing that defines a mating surface;
a plurality of first electrical conductors positioned linearly and adjacent to each other on the housing, each of the first electrical conductors having a solderable surface mount end that extends a first length from the mating surface of the housing; and
a second electrical conductor positioned in line with the plurality of first electrical conductors, the second electrical conductor having a tail that extends a second length from the mating surface of the housing;
wherein the second electrical conductor is positioned at one end of the plurality of first electrical conductors, the second length is greater than the first length, and the second electrical conductor can be received in a substrate hole.

17. The electrical connector of claim 16, further comprising a plurality of solder balls, each of the solder balls being mounted on a corresponding one of the solderable surface mount ends of the plurality of first electrical conductors.

18. The electrical connector of claim 16, wherein the second electrical conductor is a ground contact.

19. The electrical connector of claim 16, wherein the tail of the second electrical conductor is a press-fit contact.

20. The electrical connector of claim 16, further comprising an insert molded leadframe assembly having the plurality of first electrical conductors and the second electrical conductor mounted thereon.
